(19) United States
(12) Patent Application Publication
(10) Pub. No.: US 2015/0305372 A1
(43) Pub. Date: Oct. 29, 2015

(54) FEED INTAKE OF RUMINANTS USING GREEN FODDER FLAVORS

(71) Applicant: BASF SE, Ludwigshafen (DE)

(72) Inventors: Arnulf TRÖSCHER, Weinheim (DE); Nina CHALLAND, Mannheim (DE); Johanna TROESCHER, Weinheim (DE); Franziska TROESCHER, Weinheim (DE)

(21) Appl. No.: 14/696,996

(22) Filed: Apr. 27, 2015

(30) Foreign Application Priority Data
Apr. 28, 2014 (EP) 14166130.6

(51) Int. Cl. A23K 1/16; A23K 1/18

(52) U.S. Cl. CPC A23K 1/164; A23K 1/1813; A23K 1/1646

(57) ABSTRACT

The invention relates to the use of natural or synthetic green fodder flavors as feed additive for livestock, in particular for affecting the eating behavior of livestock, corresponding methods for affecting the eating behavior of livestock, and also feedstuff additives usable therefor.

The invention relates to the use of natural or synthetic green fodder flavors as feed additive for ruminants, in particular for affecting the eating behavior of ruminants, corresponding methods for affecting the eating behavior of ruminants, and also feedstuff additives usable therefor.

### BACKGROUND OF THE INVENTION

In dairy farming, efforts are constantly being made to improve milk quantity and milk quality, and also the health of dairy cattle. Inter alia, attempts are made to achieve this by optimizing the feed intake and eating behavior of the animals. Important parameters in this case are, inter alia, the daily dry matter intake (DMI), the daily fresh matter intake (FMI) and also the eating frequency and eating time.

The DM1 value is one of the most important parameters for reducing the negative energy balance, in particular in the first weeks of lactation in cows with high milk production. There are numerous studies which are concerned with investigations to clarify the metabolic regulation of DMI in dairy cattle (Ingvartsen, K. L. and J. B. Andersen 2000). Via a maximized DMI value, the health status and life expectancy of the cows can be improved (Bertics et al. 1992; Hutjens 2005, Overton 2005, 2005).

A higher feed intake means a higher intake of energy and other nutrients. As a result, the performance (milk, daily gain) of the animals can be increased, or the loss of body matter reduced.

The beneficial effect of an increased feeding frequency on the milk fat fraction (increase in fat content) is described by French, N. et al in J Dairy SC1 (1990) 73:1857-1863, A beneficial effect of the increased feeding frequency on the average daily feed intake (ADFI) and the average daily gain (ADG) is described by Schultz, J. S. et al in The Professional Animal Scientist (2011)27: 14-18.

Shortly before calving and in the first (up to ten) weeks after calving, dairy cattle give off more energy via milk than they can take in via feed. This hunger phase leads to enduring health damage which can be expressed in acute lameness, fatty liver, but also in infertility. They are one of the main reason that cows are currently only productive for approximately a further 2.7 years and thereafter must be slaughtered (Mertens 2011).

A higher number of meal times per day with lower feed intake per meal time can be associated with a beneficial effect on rumen fermentation by establishing a stable pH in the rumen ( French and J. J. Kennelly 1990) (Schutz and J. J. Wagner,4 PAS, E. D. Sharman, PAS, N. E. Davis, and T. E. Engle 2011).

Therefore, the object was to find a way as to how the feed intake behavior of dairy cattle during lactation can be further improved.

### SUMMARY OF THE INVENTION

Surprisingly, the above object was able to be achieved by specific enrichment of animal fodder with green fodder flavors.

Modern dairy farming proceeds the whole year round in the stall, that is to say without the possibility of the animal being able to go to a pasture. In the stall, silage, hay and concentrates are used all year round. In contrast to pasture grass, these feedstuffs do not have the natural olfactory stimuli which are optionally necessary for a regulation of feed intake. These olfactory stimuli lead not only to better distribution of the feed intake over the day via a higher eating frequency, in association with shorter mealtimes, but also to a higher feed intake. A performance improved by increased feed intake means an increase in feed utilization, since for the same nutrient requirement for maintenance, more nutrients are available for additional performance.

Special forms of the Invention

### a) General Definitions

Trans-hex-2-enal (CAS No. 6728-26-3/hex-2(trans)-enal/Flavis No. 05.073) and hexanal (CAS No. 66-25-1/hexanal/Flavis No. 05.008) are natural or corresponding synthetic chemically defined flavor compounds as described in the Register of feedstuff additives of the European Union (as per Regulation (EC) No. 1831/2003).

“Green fodder” or “green feedstuffs” comprise feedstuffs in which all of the plant, mostly fresh, can be fed. Examples which may be mentioned are: grass, corn, cereal, clover and legumes.

These feedstuffs are distinguished by a high fraction of structural carbohydrates. This group is overall very heterogeneous with respect to components. Grass consists predominantly of structural carbohydrates. The crude protein content is in the range of 15 to 25%. Corn, in contrast, has a large starch fraction (approximately 20-40%), but in contrast, with about 10%, markedly less crude protein. In addition, corn also contains structural carbohydrates. The cereal types are similar to corn; the legumes in principle likewise, but have markedly more crude protein.

“Livestock” within the meaning of the present invention comprises, in particular, ruminants, and especially goats, sheep, calves, cattle, and especially dairy cattle, principally dairy cows and fattening cattle.

A “changing or affecting the eating behavior” is to be understood broadly and in particular includes an increase in feed intake frequency. Optionally, this includes an increase in feed intake (kg/d), in particular of the fresh matter intake (FMI)

The daily dry matter intake (DMI) is one of the most important parameters for reducing the negative energy balance, in particular in the first weeks of lactation in cows having high milk performance.

The daily fresh matter intake (FMI) is a further important parameter for describing the eating behavior of cattle.

The frequency of feed intake (feed intake frequency) is defined as the number of individual intakes of feed (e.g. by seeking a feed trough) of an animal per unit time, e.g. per day.

“Carboxylic acids” are, in particular, straight-chain or branched, in particular straight-chain, saturated or monounsaturated or polyunsaturated, optionally substituted C₆-C₃₀-nnonocarboxylic acids. Examples of saturated unbranched fatty acids are caproic acid, enanthic acid, caprylic acid, pelargonic acid, caprinic acid, undecanoic acid, lauric acid, tridecanoic acid, myristic acid, pentadecanoic acid, palmitic acid, margaric acid, stearic acid, nonadecanoic acid, arachic acid, behenic acid, lignoceric acid, cerotic acid and melissic acid. Examples of monounsaturated fatty acids are palmitoleic acid, oleic acid and erucic acid. Examples of diunsaturated fatty acids are sorbic acid and linoleic acid. Examples of triunsaturated fatty acids are linolenic acid and elaeostearic acid. Examples of tetra- and polyunsaturated fatty acids are arachidonic acid, clupanodonic acid, eicosapentaenoic acid and docosahexaenoic acid. Examples of substituted fatty acids are ricinoleic acid ((R)-12-hydroxy-(Z)-9-octadecenoic acid). Further suitable fatty acids are naturally occurring fatty acids such as gondoic acid and neroic acid. If double bonds are present in the fatty acids, they can thus be present either in the cis or in the trans form. The substituents are preferably selected from hydroxyl and lower alkyl groups such as, e.g., methyl and ethyl groups. In addition, keto groups or epoxy groups can be present in the hydrocarbon radical such as, e.g., in vernolic acid. Other functional groups are cyclopropane, cyclopropene and cyclopentene rings which can be developed by bridging two adjacent carbon atoms in the hydrocarbon radical of the fatty acid (cf. malvalic acid and chaulrnoogric acid).

“PUFA” are polyunsaturated fatty acids having at least 2 conjugated or non-conjugated C═C double bonds in the fatty acid molecule. Examples which may be mentioned are: linolenic acid, eicosapentaenoic acid (EPA) ((5Z,8Z,11Z,14Z,17Z)-eicosa-5,8,11,14,17-pentaenoic acid; or C20:5 (?-3)) and docosahexaenoic acid (DHA) ((4Z,7Z,10Z,13Z,16Z,19Z)-docosa-4, 7,10,13,16,19-hexaenoic acid) or C22:6 (ω-3)).

“MUFA” are monounsaturated fatty acids which occur in cis or trans configuration such as, e.g., oleic acid or vaccenic acid.

Conjugated linoleic acids (CLA) are a group of isomers of the diunsaturated C₁₈; monocarboxylic acid “linoleic acid”, the two double bonds of which are in positions 9 and 12, and are therefore present in the unconjugated form. This is also named by the short form “C18:2 cis-9, cis-12”.

“CLA” comprises in principle all conjugated, diunsaturated isomers of linoleic acid (C18:2 cis-9,cis-12), wherein the position of the two double bonds in the carbon chain can be shifted towards the chain end or towards the carboxyl group and, in addition, the stereochemistry of the conjugated double bonds can comprise any variation (cis/cis, trans/trans, cis/trans), wherein “cis/trans” comprises both sequences “trans-cis” or “cis-trans”, wherein in each case the first mentioned configuration of the two sequences relates to that of the double bond closest to the carboxyl group:

By way of example, reference may be made to the conjugated linoleic acid “C18:2 cis-9, trans-11” shown hereinafter:

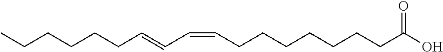 [SMILES: CCCCCC/C=C/C=C\CCCCCCCC(=O)O]

The names used herein: cis/trans-9,11-linoleic acid; cis/trans-8,10-linoleic acid; cis/trans-11,13-linoleic acid; and cis/trans-10,12-linoleic acid; therefore comprise not only the cis-trans, but also the trans-cis isomers, therefore:

cis/trans-9,11-linoleic acid comprises: C18:2 cis-9, trans-11 and C18:2 trans-9, cis 11
cis/trans-8,10-linoleic acid comprises: C18:2 cis-8, trans-10 and C18:2 trans-8, cis 10
cis/trans-11,13-linoleic acid comprises: C18:2 cis-11, trans-13 and C18:2 trans-11, cis 13
cis/trans-10,12-linoleic acid comprises: C18:2 cis-10, trans-12 and C18:2 trans-10, cis 12.

The same applies to triunsaturated linolenic acid (C18:3, cis-9, cis-12, cis-15) and the cis/trans isomers thereof.

The above material particulars and the uses of these materials described herein relate primarily to the respective pure substance or else to natural or synthetic mixtures of matter which contain at least one of these materials, e.g. at least one PUFA or at least one CLA.

Natural mixtures of matter are, e.g., fish oils or microbial oils, which can be rich in PUFAs, and also linseed oil, soya bean oil, sunflower seed oil, castor oil, etc.

Synthetic mixtures of matter are, for example, CLA-rich commercial products such as Lutalin® from BASF SE.

### b) Particular Embodiments

The present invention relates in particular to:

1. The use of natural or synthetic green fodder flavors as feed additive for livestock, in particular. for changing the eating behavior of livestock; such as in particular for increasing the feed intake (kg/d) and/or for increasing the frequency of feed intake (feed intake frequency).
2. The use according to embodiment 1, wherein the green fodder flavors comprise C₆-breakdown products of long-chain fatty acids.
3. The use according to any one of the preceding embodiments, wherein the green fodder flavors comprise hexanal and/or at least one monounsaturated or polyunsaturated analog thereof; wherein the flavoring agent is essentially composed of hexanal and I or one or more of its mono- or poly-unsaturated analogs. In particular, the flavoring agent may be used in its pure form, i.e, undiluted. The undiluted flavor is either unsupported or used for easier incorporation in supported form. Suitable carrier/supports are e.g. those which are known as feed-compatible organic or inorganic carriers. As examples, the secondary cereal products listed below, such as wheat bran, or inorganic salts, such as sodium chloride or calcium carbonate, may be mentioned, without being limited thereto.
4. The use according to embodiment 3, wherein the analogs are selected from 2-, 3- and 4-hexenals, in each case in the cis- or trans-form, preferably trans-hex-2-enal.
5. The use according to any one of the preceding embodiments, wherein the livestock is selected from goats, sheep, calves, cattle and in particular dairy cattle, especially dairy cows and also fattening cattle, preferably dairy cows.
6. The use of green fodder flavors according to the definition according to any one of the preceding embodiments 1 to 4 for affecting the eating behavior of livestock, in particular livestock as claimed in embodiment 4.
7. The use according to embodiment 6 for increasing the feed intake (kg/d) and/or the frequency of feed intake (feed intake frequency).
8. The use according to embodiment 7 for increasing the fresh matter intake (FMI) (kg/d).
9. A feedstuff supplemented with green fodder flavors according to the definition in any one of embodiments 1 to 4.
10. A method for affecting the eating behavior, such as, in particular, for increasing the feed intake (kg/d) and/or the frequency of feed intake (feed intake frequency) of livestock, where feed is administered to the livestock, which feed is supplemented with a feed additive according to the definition in any one of embodiments 1 to 4.
11. The use, feedstuff or method according to any one of the preceding embodiments, wherein the green fodder flavor(s) are used in an amount which is sufficient to give the livestock a daily dose of 0.05 to 10, 0.1 to 8, 1 to 5, or 2 to 4 g/animal/d. In particular, the feed is supplemented with said green fodder flavor(s) in a dose from 0.0025 to 0.5 g/kg, in particular from 0.005 to 0.4 g/kg, preferably 0.05 to 0.25 g/kg, and especially 0.1 to 0.2 g/kg (based on the total weight of the supplemented feed).
12. A feedstuff additive comprising at least one green fodder flavor according to any one of embodiments 1 to 4 in combination with at least one further usual feed additive, in particular selected from vitamins, minerals, trace elements and fatty acids, in particular conjugated fatty acids.
13. The feedstuff additive according to embodiment 12, wherein the fatty acid comprises a polyunsaturated fatty acid, in particular an isomer of linoleic acid.
14. The feedstuff additive according to embodiment 13, wherein the polyunsaturated fatty acid is a CLA.
15. The feedstuff additive according to embodiment 14, wherein the CLA is selected from

a) cis/trans-9,11-linoleic acid,
i.e. C18:2 cis-9, trans-11 and C18:2 trans-9, cis 11

b) cis/trans-8,10-linoleic acid;
i.e.C18:2 cis-8, trans-10 and C18:2 trans-8, cis 10

c) cis/trans-11,13-linoleic acid;
i.e. C18:2 cis-11, trans-13 and C18:2 trans-11, cis 13

d) cis/trans-10,12-linoleic acid;
i.e. C18:2 cis-10, trans-12 and C18:2 trans-10, cis 12

e) cis/cis-9,11-linoleic acid,

f) trans/trans-9,11-linoleic acid,

g) cis/cis-8,10-linoleic acid

h) trans/trans-8,10-linoleic acid

i) cis/cis-11,13-linoleic acid

j) trans/trans-11,13-linoleic acid

k) cis/cis-10,12-linoleic acid

l) trans/trans-10,12-linoleic acid; and mixtures of at least two of the abovementioned compounds.

16. The feedstuff additive according to embodiment 15, wherein the CLA is selected from

a) 9-cis,11-trans-linoleic acid;

b) 10-trans,12-cis-linoleic acid; and

c) mixtures thereof.

c) Producing the Feedstuff Supplemented with Green Fodder Flavors

The production proceeds in a simple manner in that the desired amount of green fodder flavor, in particular hexanal or a monounsaturated or polyunsaturated analog thereof, or a mixture of such flavors, optionally mixed with further additives, preferably in pure form or as mixture of such grass flavors without further additives, is added to a precharged non-additivized feed mixture or a precharged feedstuff additive (e.g. dropwise addition or spraying of a dilute, preferably undiluted solution of such flavor or mixture of such flavors or addition of a flavor compound-containing premix, as for example a feed compatible carrier soaked with such a flavor of mixture of such flavors, to the total mixed ration (TMR) and subsequently further mixed until uniform distribution of the flavor. The feed thus produced can then be fed directly.

### d) Feed Ingredients

Typical feed ingredients which are usable for producing feedstuffs according to the invention comprise individual feedstuffs of plant or animal origin according to the German foodstuffs regulation (Futtermittelverordnung FMV), such as, for example, secondary cereal products, wheat feed meal, wheat bran; extracted meals, pomace, dried molasses pulp, fish meal, meat and bone meals; and/or individual mineral foodstuffs as under FMV, such as, e.g., carbonates, phosphates, sulfates, propionates. Those which are likewise suitable are cereals, such as wheat, rye, barley, oats, corn, millet or triticale; secondary cereal products (byproducts of milling), such as brans, semolina brans, wheat semolina brans, feed meals or secondary meals; byproducts from oil production (extracted meals, expeller, cake); byproducts from production of sugar (molasses, dried cossettes, feed sugar, pulps, potato starch, corn gluten, wheat gluten); byproducts of the fermentation industry, brewers' grains, yeast, malt sprouts, distillers' dried grains; and also animal and other feedstuffs such as blood meal, fish meal, pressed juice, potato protein.

Those which may be mentioned in particular are wheat, corn grain, barley, oats; soybeans; cereal flours, such as wheat or cornflour, soybean meal, beet molasses pellets, wheat semolina bran, wheat middlings, corn gluten feed, soy extraction meal, rapeseed extraction meal, brewers' grains, dried distillers' grains, beet molasses, oat bran; sugars, such as corn sugar, and sugar alcohols, in addition proteinaceous components such as soy concentrate, fish meal, glutens such as corn or wheat gluten, oils and fats, and also neutraceuticals, such as, e.g., free amino acids, salts thereof, vitamins (such as, e.g., A, D, E) and trace elements (such as, e.g., Cu as CuSO₄), mineral components, such as calcium carbonate, sodium chloride; phosphates, and also optionally processing auxiliaries, e.g. lubricants, inert fillers and the like, and optionally preservatives.

Typical milk-yield feed compositions contain, e.g., corn, wheat, barley, oats, rye, citrus pomace, soybean extraction meal, rapeseed extraction meal, soy hulls, palm kernel expeller, DDGS, corn gluten feed, sugarbeet cossettes, wheat semolina bran, wheat bran, linseed, molasses, chalk, salt, vitamin and trace element premix.

The invention will now be described in more detail with reference to the following exemplary embodiments.

### Experimental Section

### EXAMPLE 1

### Study of the Effect of Trans-hex-2-enal and Hexanal on the Feed Intake of Dairy Cows having a High Milk Performance (German Holstein cattle)

The purpose of the present study is to establish whether 4.3 g/cow/day of trans-hex-2-enal or 4.3 g/cow/day of hexanal affect the DMI value, the milk performance, the milk composition or the feed intake behavior (duration, frequency, etc.) of dairy cows.

### a) Material and Methods

### 1. Treatment Regimen

In total 62 German Holstein cattle (Teaching and Experimental Institute for Animal Husbandry, Hofgut Neumahle, Rural Area Service Center, Western Palatinate) were randomly divided among three comparable animal groups (cf. table 1).

TABLE 1
Classification of the cows

| | Ø days in | Ø lactation | Ø milk |
|---|---|---|---|
| Group | milk (DIM) | number | (kg/day) |
| Control (n = 22) | 136 +/− 61 | 2.6 +/− 1.6 | 33.5 +/− 5.4 |
| Group A* (n = 20) | 134 +/− 87 | 2.5 +/− 1.3 | 33.9 +/− 6.6 |
| Group B* (n = 20) | 136 +/− 82 | 2.6 +/− 1.5 | 33.9 +/− 7.6 |

(A*: Trans-hex-2-enal; B*: Hexanal)

The start of the study was calendar week 18 of the experimental year and the end of the study was calendar week 24 of the same year. The feed consumption was determined by means of feed troughs with electronic weight determination, produced by Insentec B.V. (Marknesse, Netherlands). The system identifies each animal by scanning the respective transponder on the neck band of the respective cow using a light barrier. After identification, the animal is allowed free access to the feed trough and the amount of feed taken in on each visit to the trough is recorded automatically.

The system thus determines all visits of each cow to the feed trough, the respective feed intake and the duration of the respective visit. The feed troughs were filled once a day at about 06.30 hours in the morning with an amount of about 70 kg of feed, after the residual feed of the previous day had been removed. During the morning milking, the feed troughs were closed for cleaning for a period of 20 to 30 minutes.

The milking parlor was a combination of a herringbone milking parlor with space for eight cows and a side-by-side milking parlor with space for ten cows, manufactured by GEA Farm Technologies (Boenen, Germany).

The milk yield was determined individually during each milking process and recorded by the Herd Management Software DairyPlan C21 (GEA Farm Technologies, Boenen, Germany). The cows were milked twice daily at 05.00 hours in the morning and 15.30 hours in the afternoon. Fresh water was freely available at all times.

Every Monday, after each milking, milk samples were taken and, for each cow, the milk composition (fat, protein, somatic cell count) was determined. The energy-corrected milk value (ECM) was determined according to the following equation:

ECM=(1.05+0.38×milk fat(%)+0.21×protein(%)/3.28,

All of the cows received a total mixed ration (TMR) (table 2) having a calculated mean daily feed intake of 22 kg of dry matter (DM). Trans-hex-2-enal and hexanal were added to the TMR and thus fed by a premix with wheat bran (trans-hex-2-enal/wheat bran for group A and hexanal/wheat bran for group B).

TABLE 2
Composition and nutrient analysis
of the feed (kg of DM and % DM)

| Component | Control | Group A* | Group B* |
|---|---|---|---|
| Sugarbeet silage | | 4.0 (17.8) | |
| Grass silage | | 4.6 (21.3) | |
| Corn silage | | 4.6 (21.1) | |
| Hay | | 0.4 (1.2) | |
| Straw | | 0.3 (2.0) | |
| Barley | | 1.8 (8.0) | |
| Corn meal | | 2.2 (10.0) | |
| Solvent-extracted rape meal | | 3.5 (16.1) | |
| Salt, limestone, urea, minerals | | 0.5 (2.5) | |
| Trans-hex-2-enal (g/cow/day) | — | 4.3 | — |
| Hexanal (g/cow/day) | — | — | 4.3 |
| NEL (Net energy for lactation) | | 6.8 | |
| (MJ/kg DM) | | | |
| Utilizable crude protein (g/kg DM) | | 152 | |
| Rumen nitrogen balance (g/kg DM) | | 0.4 | |

(A*: Trans-hex-2-enal; B*: Hexanal)

Samples of the TMR were withdrawn daily from each of the rations, combined to form a weekly sample and frozen until determination of the DM content of the TMRs. Samples of all feed components were taken every 14 days, frozen and pooled over the entire feeding trial up until laboratory analysis.

### 2. Statistical Analyses

A standard model for statistical analysis using all parameters was adapted to the weekly data. This is a general, linear, mixed model with the cow as a chance effect and containing the following co-variables:

1. the lactation number as a categorical variable

2. the lactation week as a continuous variable including a quadratic term

3. the experimental week as a categorical variable

For the treatment effect, an “overall” P value was presented, and also a P value for the differences between the groups, which were tested both adapted and also non-adapted by means of the Tukey test.

### b) Results

### 1) DMI and Milk Production

The cows exhibited a higher (p<0.0001) fresh matter intake (FMI) value in group A and group B compared with the control group. The highest daily FMI value was reached by group B with a mean of 48.3 kg FMI per day. In this case, no difference was observed between the groups for the daily DMI value.

On the basis of dry matter intake (DMI), also, a significant advantage resulted for the two groups A and B compared with the control group (A vs control: p<0.067 and B vs control: p<0.0234). Because additional processes are necessary for determining the dry matter (sampling, drying, weighing), additional scattering resulted which reduces the differences between the groups.

Cows of group A visited the feed trough 48.6 times per day; group B visited the trough 45.2 times per day. In contrast to these results, in the control group, only 33.1 visits per day were observed on average. Therefore, animals of group A visited the feed trough 47% more frequently and animals of group B visited the trough 37% more frequently than animals of the control group (table 3).

No differences were observed between the groups with respect to daily milk yield and milk composition.

TABLE 3
Feed intake, milk production, milk composition and body status (LSQ means)

| | Number | Control | | | |
|---|---|---|---|---|---|
| | of | group | Group A* | Group B* | |
| Components | values | (n = 22) | (n = 20) | (n = 20) | p value |
| FMI^{a} (kg/d) | 62 | 43.6^{a} | 47.8^{b} | 48.3^{b} | p < 0.05 |
| DMI (kg/d) | 62 | 22.2^{a} | 23.5^{ab} | 23.8^{b} | p < 0.05 |
| DMI (% of BW^{b}) | 62 | 3.3 | 3.6 | 3.7 | not specified |
| Frequency of visits | 62 | 33.1^{a} | 48.6^{b} | 45.2^{b} | p < 0.0001 |
| Eating period (min) | 62 | 184^{a} | 206^{ab} | 212^{b} | p < 0.05 |
| Milk yield (kg/d) | 62 | 31.6 | 33.1 | 32.7 | not specified |
| ECM (kg/day) | 62 | 30.2 | 31.1 | 31.3 | not specified |
| Milk fat (%) | 62 | 3.69 | 3.66 | 3.77 | not specified |
| Milk protein (%) | 62 | 3.36 | 3.26 | 3.28 | not specified |
| Milk fat yield (kg/d) | 62 | 1.16 | 1.19 | 1.22 | not specified |
| Milk protein yield (kg/d) | 62 | 1.04 | 1.06 | 1.06 | not specified |
| MUN^{c} (mg/l) | 62 | 239 | 236 | 241 | not specified |
| Body weight (kg) | 62 | 670 | 671 | 653 | not specified |
| BFT^{d} (cm) | 62 | 0.96 | 0.93 | 0.92 | not specified |

A*: Trans-hex-2-enal;
B*: Hexanal;
^{a}Fresh matter intake;
^{b}BW = body weight;
^{c}milk-urea-nitrogen;
^{d}BFT = Back Fat Thickness

### 2) Summary

The purpose of this study was to establish what effect trans-hex-2-enal and hexanal display on the feed intake (FMI, DMI), milk production and milk composition.

Trans-hex-2-enal and Hexanal significantly increased the daily FMI value in comparison with the control group. This also applies to the DMI value. There were no differences in comparison with the control group with respect to the daily milk production and the milk composition. Groups A and B visited the feed troughs 47% and 37%, respectively, more frequently per day than the control group. A higher number of feeding times per day with a lower feed intake per feeding time and significantly longer eating time can be associated with a beneficial effect on rumen fermentation by establishing a stable pH in the rumen. A stable pH in the rumen is rated in the literature as an important precondition for a high performance (milk and daily gain) and good health. Correspondingly, products are promoted and used such as: buffer substances, antibiotics and live yeast.

Reference is made explicitly to the disclosure of publications cited herein.

### REFERENCES

Bertics, S J, Ric R. Grummer, Carlos Cadorniga-Valino, Emily E. Stoddard (1992) Effect of Prepartum Dry Matter Intake on Liver Triglyceride Concentration and Early Lactation. Journal of Dairy Science 75, 1914-1922.
French, N, J. J. Kennelly (1990) Effects of Feeding Frequency on Ruminal Parameters, Plasma Insulin, Milk Yield, and Milk Composition in Holstein Cows. Journal of Dairy Science 73, 1857-1863.
Hutjens, MF (2005) Dairy Efficiency and Dry Matter Intake. In ‘Proceedings of the 7th Western Dairy Management Conference’ pp. 71-76. (Reno, Nev.)

### Ingvartsen, K. L. and J. B. Andersen (2000) Integration of Metabolism and Intake Regulation: A Review Focusing on Periparturient Animals 83, 1573-1597.

Mertens, H (2011) Leistung ohne Grenzen. Milchpraxis 2011 (1), 12-14.

### N. French, J. J. Kennelly Effects of Feeding Frequency on Ruminal Parameters, Plasma Insulin, Milk Yield, and Milk Composition in Holstein Cows

Overton, T R (2005) Optimizing Intake in Dry and Prefresh Cows [Online]. Available at http://www.wdmc.org/2011/Optimizing%20Intake%20in%20Dry%20and%20Prefresh%20Cows %20pg%20195-206.pdf (verified 14 Apr. 2014)
Schutz, J S, J. J. Wagner,4 PAS, E. D. Sharman, PAS, N. E. Davis, and T. E. Engle (2011) Effect of feeding frequency on feedlot steer performance. The Professional Animal Scientist 27, 14-18.

1.-15. (canceled)

16. A feed additive for affecting the eating behavior of livestock which comprises natural or synthetic green fodder flavors.

17. The additive according to claim 16, wherein the green fodder flavors comprise C₆-breakdown products of long-chain fatty acids.

18. The additive according to claim 16, wherein the green fodder flavors comprise hexanal and/or at least one monounsaturated or polyunsaturated analog thereof.

19. The additive according to claim 18, wherein the analogs are selected from 2-, 3- and 4-hexenals, in each case in the cis- or trans-form.

20. The additive according to claim 16, wherein the flavors consist essentially of hexanal and/or one or more monounsaturated or polyunsaturated analogs thereof.

21. The additive according to claim 16, wherein the flavors used are in undiluted form, optionally provided on a feed-qualified carrier.

22. A feedstuff supplemented with green fodder flavors.

23. A method for affecting the eating behavior of livestock, where feed is administered to the livestock, which feed is supplemented with the feed additive according to claim 16.

24. The method of claim 23, wherein said change in eating behavior is an increase of the frequency of feed intake (feed intake frequency)

25. The method according to claim 23, wherein the livestock is selected from goats, sheep, calves, cattle and in particular dairy cattle,

26. The method according to claim 23, wherein the livestock is selected from dairy cows.

27. The method according to claim 23 for increasing the fresh matter intake (FMI) (kg/d).

28. The method according to claim 23, wherein the green fodder flavor(s) are used in an amount which is sufficient to give the livestock a daily dose of 0.05 to 10 g/animal/d.
